(19) United States
(12) Patent Application Publication
(10) Pub. No.: US 2009/0078233 A1
(43) Pub. Date: Mar. 26, 2009

(54) ENGINE BRAKE PROCEDURE

(75) Inventors: Andre F. CASAL KULZER, Boeblingen (DE); Martin A. Rauscher, Ludwigsburg (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/236,228

(22) Filed: Sep. 23, 2008

(30) Foreign Application Priority Data
Sep. 25, 2007 (DE) 10 2007 045 643.5

(51) Int. Cl. F02D 13/04; F01L 13/06

(52) U.S. Cl. 123/321

(57) ABSTRACT

The invention concerns a procedure for the braking of a vehicle, especially a motor vehicle, that is operated by a combustion engine, at which the braking torque is initiated into a drive train of the vehicle, by compressing gas in at least one cylinder of the combustion engine during the compression stroke and by discharging the compressed gas at the end of the compression stroke through at least one opened outlet valve from the cylinder. It is provided that the outlet valve is slightly opened before or during the compression stroke and widely opened at the end of the compression stroke.

### TECHNICAL FIELD

The invention concerns a procedure for braking a vehicle that is powered by a combustion engine according to the genus of claim 1.

### BACKGROUND

The braking of a motor vehicle by exploiting the braking effect of the combustion engine in order to discharge the vehicle's brakes is generally termed as engine brake. An engine brake that is appropriate for two-stroke or four-stroke engine with valve controlling, which is also called ‘Jake Brake’, the outlet valves of the cylinder are opened with the aid of the valve controlling at the end of the compression stroke shortly before the upper dead center of the piston. By opening the outlet valves the pressure in the cylinders is reduced, so that after the negative torque (braking torque), which has been initiated during the compression stroke into the crankshaft, at the following cycle no positive torque (driving torque) can be brought up from the pistons to the crankshaft. Thereby the combustion engine performs a braking effect over the drive train onto the driving wheels of the vehicle, so that the vehicle is slowed down.

However this type of engine brake requires greater forces in order to raise up the outlet valves of the cylinders from its valve seat by use of the valve drive and to open them against the present pressures in the cylinder. If these forces are taken into account when construing the valve drive the energy demand of the valve drive raises, for example the electro hydraulic energy demand at electro hydraulic valve drives, in all operating areas of the combustion engine, which again results in an enhancement of the fuel consumption.

Based on this the invention underlies the task to improve an engine brake procedure of the type that has been described in the beginning in such a way that by reducing the forces that are required during the engine braking to open the valves the fuel consumption of the combustion engine can be decreased or the efficiency of the combustion engine can be improved.

### SUMMARY

This task is accomplished according to the invention by opening the outlet valve slightly before or during the compression stroke and widely at the end of the compression stroke.

If the outlet valve is already opened slightly during the compression stroke and thereby raised slightly from the valve seat, smaller forces are required for a complete opening of the valve than in the case of a closed valve that has to be opened. Thereby not only the energy demand of the valve drive can be reduced at the engine braking, but also the valve drive can be construed for lower maximum opening forces, whereby the energy that is required for opening the valve in other operating areas of the combustion engine and thereby also the fuel consumption of the vehicle can be reduced.

In order to minimize the force that is required to open the valve on the one hand, but also to avoid a notable reduction of the maximum braking torque due to the slightly opened valve, a preferred embodiment of the invention provides that the outlet valve is opened before or during the compression stroke less than 1.0 mm, preferably less than 0.5 mm and at best less than 0.25 mm. Preferably the outlet valve is already slightly opened at the beginning of the compression stroke when the force that is required for raising the valve from the valve seat is still very low.

A further advantageous embodiment of the invention provides that the braking torque that is initiated by the engine braking in the drive train is controlled by increasing or decreasing the amount of gas that is discharged through the outlet valve. This can take place by increasing or decreasing the lifting height of the outlet valve that is either opened slightly or widely. Alternatively the braking torque can be also controlled by changing the opening or closing moments of the valve, for example the closing moment of the valve during the compression stroke or the opening moment of the valve during the following expansion stroke.

At combustion engines with several valves, which means more than one outlet valve per cylinder, all outlet valves are practically slightly opened before or during the compression stroke, but at least the outlet valves that are opened widely at the end of the compression stroke. Besides the outlet valves also the inlet valves can be opened if necessary, whereby in this case the described procedure also applies for the inlet valves.

In order to avoid the emission of exhaust fumes through the opened valve or valves, no fuel is added into the cylinder before or during the compression stroke so that only air is compressed as gas in the cylinder according to a further preferred embodiment of the invention.

### BRIEF DESCRIPTION OF THE DRAWINGS

The invention is described in the following by use of embodiments that are shown in the drawings:

FIG. 1 shows a section view of a part of a cylinder of a combustion engine during the engine brake operation during the induction stroke;

FIG. 2 shows a section view corresponding with FIG. 1 during the engine brake operation at the beginning of the compression stroke;

FIG. 3 shows a section view corresponding with FIG. 1 during the engine brake operation shortly before the end of the compression stroke; and

FIG. 4 shows a section view corresponding with FIG. 1 during the engine brake operation at the end of the compression stroke.

### DETAILED DESCRIPTION

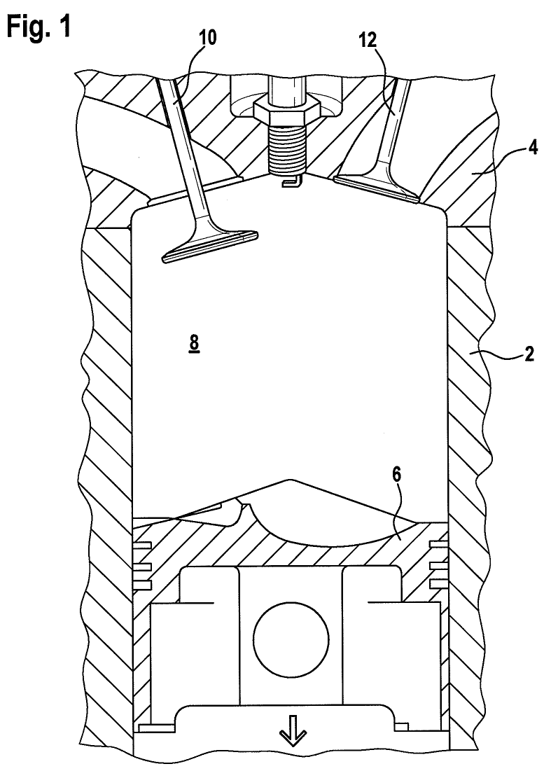

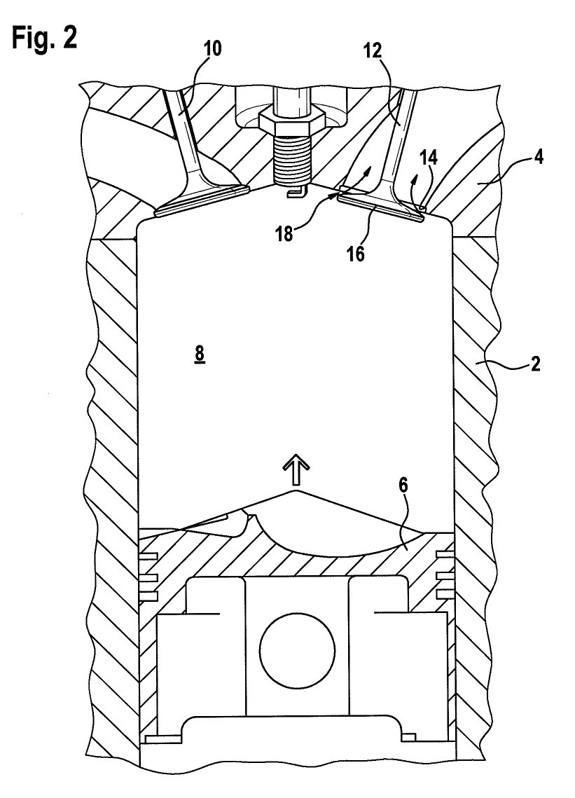

The cylinder 2 of a four-cylinder four-stroke Otto engine with a variable valve drive of a motor vehicle that is partially shown in FIGS. 1 and 2 of the drawing provides a combustion chamber 8, which is limited by a cylinder head 4 and by a piston 6 and which is connected to an air induction stroke over two inlet valves 10 and to an exhaust duct of the engine over two outlet valves 12 (showing only one). The opening and closing of the inlet- and outlet valves 10 and 12 takes place with the aid of a electro hydraulic valve controlling of the engine (not shown).

During the engine brake operation fresh air is sucked into the combustion chamber 8 during the induction stroke of the engine at an opened inlet valve 10, while the piston 6 is moving towards its lower dead center as shown in FIG. 1. After the inlet valves 10 have been closed, the two outlet valves 12 are each raised from their valve seat 14 by about 0.5 mm at the beginning of the consequent compression stroke, so that a narrow air gap is present between the valve seat 14 and the adjacent edge of the valve plate 16 of the outlet valves as it is shown slightly exaggerated in FIG. 2.

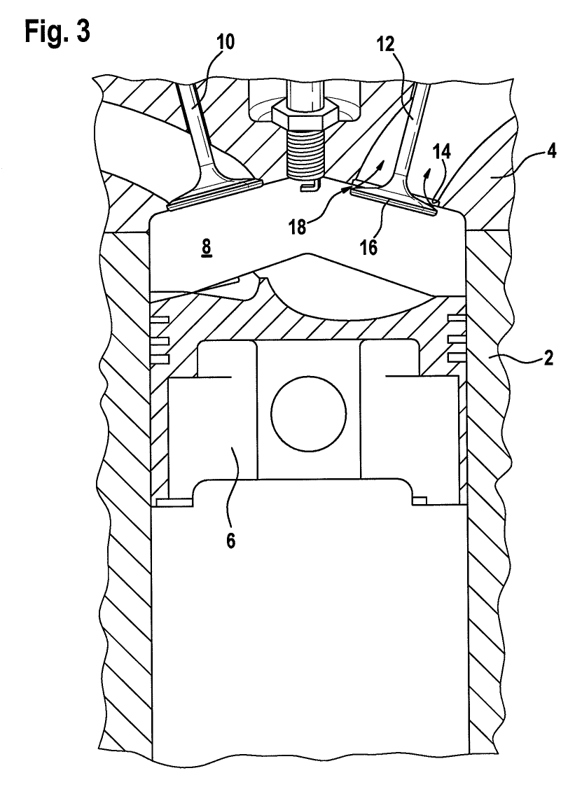

The two outlet valves 12 are kept in this position until the end of the compression stroke as shown in FIG. 3, while the piston 6 is moving towards its upper dead center and the sucked in air is compressed inside the cylinder 2. Hereby a braking torque is basically produced onto the crankshaft over the piston 6 for the whole duration of the compression stroke.

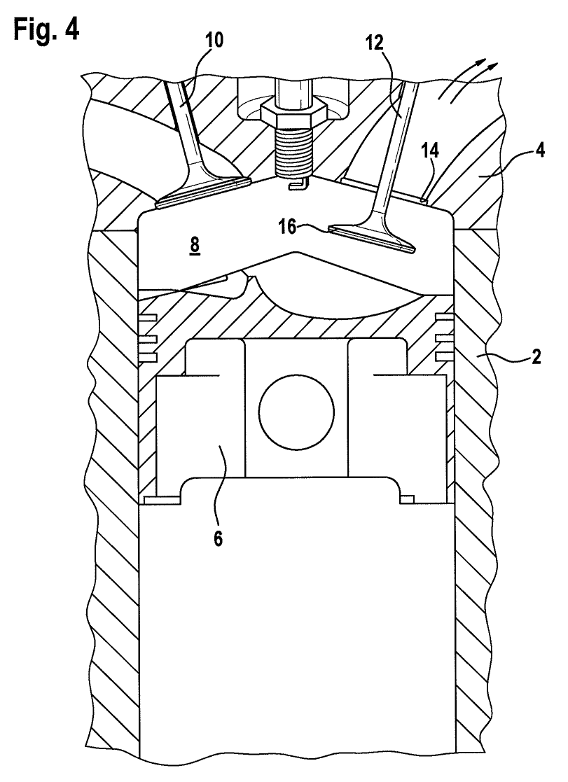

If the piston 6 is located at the end of the compression stroke near its upper dead center, the two outlet valves 12 are opened widely as shown in FIG. 4. Thereby the compressed air is abruptly relaxed in the combustion chamber 8 and emitted through the outlet valves 12 into the exhaust duct as shown by the arrow A in FIG. 4.

By the previous slight lifting of the outlet valves 12 from their valve seats 14 the pressure difference decreases at the opposite sides of the valve plate 16, whereby the force that is required at the end of the compression stroke in order to open the valves 12 against the pressure in the combustion chamber 8 widely, is essentially smaller as at entirely closed valves 12.

During the following cycle (not shown) the piston 6 cannot provide a drive torque onto the crankshaft since it does not come to an ignition of an igniting mixture in the upper dead center of the piston 6 and therefore during the cycle not to an expansion of exhaust gases for one thing and since there is no more compressed air in the combustion chamber 8, which can press during the cycle onto the piston 6, due to the emission of the compressed air through the outlet valves 12 for another thing. Therefore the work that has to be accomplished by the piston 6 during the compression stroke is not confronted with an energy gain of the piston 6. The crankshaft is therefore entirely slowed down and therefore also the drive train of the motor vehicle that is linked with the crankshaft.

The braking torque that is initiated into the crankshaft by each piston 6 of the engine can be controlled in different ways, for example by the lifting height or the opening time of the outlet valves 12 at the end of the compression stroke, in other words by the amount of compressed air that is released at the end of the compression stroke form the cylinder 2. The bigger this air amount the greater the braking torque.

Since compressed air also escapes through the gap 18 from the combustion chamber 8 at slightly opened outlet valves, as shown in FIGS. 3 and 4 by the small arrows, the braking torque can also be controlled by changing the amount of escaping air through the gap 18 from the combustion chamber 8 during the compression stroke. The braking torque can be reduced for example by lifting the outlet valves 12 during the compression stroke by a bigger amount from the valve seat, which means for example by 1 mm instead of 0.5 mm. Contrariwise the braking torque can be increased by lifting the outlet valves 12 during the compression stroke by a very small amount from the valve seat, which means for example 0.25 mm instead of 0.5 mm. A further possibility is to change the moment, at which the outlet valves 12 are opened slightly or widely. When these moments are selected earlier, less pump work has to be accomplished by the piston 6 during the compression stroke, whereby the braking torque is reduced. Later opening moments increase the pump work and therefore the braking torque.

To avoid the emission of exhaust gas into the environment through the opened outlet valve 12 of the cylinder 2, the fuel supply into the cylinder 2 is turned off during the engine brake, so that only air is compressed by the piston 6.

1. A method of braking a vehicle that is powered by a combustion engine, especially the braking of a motor vehicle with the aid of the combustion engine, the method comprising:
initiating a braking torque into a drive train of the vehicle by compressing a gas in at least one cylinder of the combustion engine during a compression stroke; and
discharging the compressed gas at an end of the compression stroke through at least one outlet valve from the at least one cylinder;
wherein the at least one outlet valve is opened slightly before or during the compression stroke and widely at the end of the compression stroke.

2. A method according to claim 1, further comprising opening the at least one outlet valve before or during the compression stroke by less than 1.0 millimeter.

3. A method according to claim 1, further comprising opening the at least one outlet valve before or during the compression stroke by less than 0.5 millimeters.

4. A method according to claim 1, further comprising opening the at least one outlet valve before or during the compression stroke by less than 0.25 millimeters.

5. A method according to claim 1, further comprising restricting the addition of fuel into the at least one cylinder before or during the compression stroke.

6. A method according to claim 1, further comprising slightly opening the at least one outlet valve at the beginning of the compression stroke.

7. A method according to claim 1, further comprising controlling the braking torque that is initiated into the drive train by changing a lifting height of the at least one outlet valve during the compression stroke or at the end of the compression stroke.

8. A method according to claim 1, further comprising controlling the braking torque that is initiated into the drive train by changing a moment at which the at least one outlet valve is slightly and/or widely opened.

9. A method according to claim 1, further comprising controlling the braking torque that is initiated into the drive train by changing a moment at which an opened at least one outlet valve is closed.

10. A method according to claim 1, further comprising slightly opening the at least one outlet valve before or during the compression stroke and widely at the end of the compression stroke.

11. A method according to claim 1, further comprising slightly opening the at least one outlet valve and an at least one inlet valve before or during the compression stroke and widely at the end of the compression stroke.
